(19) United States
(12) Patent Application Publication
(10) Pub. No.: US 2010/0198977 A1
(43) Pub. Date: Aug. 5, 2010

(54) Automatic live stream trees

(75) Inventors: Pritham Shetty, Los Altos, CA (US); Srinivas Manapragada, Fremont, CA (US)

Correspondence Address: FISH & RICHARDSON P.C., P.O. Box 1022, MINNEAPOLIS, MN, 55440-1022, US

(73) Assignee: Adobe Systems Incorporated, San Jose, CA (US)

(21) Appl. No.: 11/527,817

(22) Filed: Sep. 27, 2006

(51) Int. Cl. G06F 15/16

(52) U.S. Cl. 709/231

(57) ABSTRACT

A video streaming network is described for streaming video to a client application. The client application broadcasts a request for an available edge server that is capable of facilitating the streaming video from the origin server. A user enters a resource locator into an interface of the client application for identifying the location of the streaming video on the origin server. This resource locator is transferred from the client application to the available edge server. Using the resource locator, the available edge server initiates a connection to the origin server and requests the origin server to transmit it a copy of the streaming video. The available edge server will then copy and transmit its copy of the streaming video to any client application that it is connected to and that has requested the streaming video.

### CROSS-REFERENCE TO RELATED APPLICATIONS

The present application is related to co-pending, commonly-assigned U.S. patent application Ser. No. 11/263,652 entitled, “NETWORK CONFIGURATION WITH SMART EDGE SERVERS;” and co-pending, commonly-assigned U.S. patent application Ser. No. 11/263,074 entitled, “VIRTUAL GROUP CONNECTION,” the disclosures of which are incorporated herein by reference.

### TECHNICAL FIELD

The present invention relates, in general, to distributed computing, and, more particularly, to automated live stream trees.

### BACKGROUND OF THE INVENTION

As bandwidth, compression, and processing capabilities have advanced in Internet technology, streaming video over the Internet has become more realistically obtainable. Streaming video is the nearly simultaneous play of a media file or other video source located at a remote location. The video data is transmitted from the remote source to the requesting client, which buffers a certain amount of the data before it begins playing the video to the user. The buffering allows the playback to be more smooth when network congestion or latency causes delay in the video data arriving at the client. The goal of the buffer is to optimize the amount of data stored at the client to allow for the smooth play while still providing responsive playback. The video data is generally stored only temporarily on the client during the streaming playback.

In operation, for each client that desires to subscribe to or view the media, the central or origin server typically establishes a high-reliability connection between the central server and the client. This connection includes all intermediate connections between the central server, any intervening servers, and the client. Developers, creating an application for providing streaming video, typically write complex code that explicitly sets up each connection between the origin server and the requesting client. This complex coding makes designing a large streaming video network very time consuming and involved.

In addition to the coding complexity, scalability is also a concern. The central or origin server creates a copy of the video information stream for each client viewing the streaming video. Therefore, the origin server can only service as many clients as its processing limits allow. Once that number is reached, no further clients may subscribe to the stream. Thus, streaming video networks are typically limited to the processing capabilities of the various central or origin servers and the ability of the developers to code the appropriate communications paths between the central server and each particular client.

FIG. 1 is a block diagram illustrating typical streaming video network 10. Streaming server 100 provides a dedicated video streaming service for various customers and clients to subscribe to available video streams, whether live-captured or pre-recorded. Clients 101-103 operate a client-side application for facilitating the implementation of streaming video network 10. The client-side application includes code and/or scripting that enables the communication set up between streaming server 100 and clients 101-103. Streaming server 100 includes server-side logic that works in conjunction with the client-side application.

Before clients 101-103 can observe any video streams, streaming server 100 establishes a dedicated communication channel between streaming server 100 and each of clients 101-103. Streaming server 100 communicates with the various interim servers, servers 104-106, to establish a dedicated channel. Depending on various network conditions, streaming server 100 may provide a communication channel between various interim servers. For example, streaming server 100 establishes communication channel A with client 101. Communication channel A provides a connection between streaming server 100 and server 104, server 104 and server 105, server 105 and server 106, and finally server 106 and client 101. Streaming server 100 establishes communication channel B with client 102 that goes between streaming server 100 and server 104 and then server 104 and client 102. Streaming server 100 also establishes communication channel C with client 103 that goes between streaming server 100 and server 104, server 104 and server 105, and then server 105 and client 103. The streaming video cannot begin playing on clients 101-103 until the corresponding communication channels are established.

### BRIEF SUMMARY

The present invention is directed to a system and method for delivering streaming video to subscribing client applications. Instead of requiring the application developers to include complex code logic to facilitate a media connection between the central or origin server and the individual client applications, representative embodiments of the present invention automatically provide for the client application to negotiate with edge servers when available to assist in delivering the streaming content. The user only enters a streaming video resource locator. The transactions occurring between the client application and the edge servers is transparent to the user.

In order to find an available edge server, the client application broadcasts an availability request for any edge servers that may be capable and available to assist the streaming delivery. Any capable and available edge server will send a response back to the client application. The client application will select a particular edge server based on the acknowledgment and any other desirable parameters that may be provided, such as geographic proximity, congestion, efficiency, or the like.

The user enters the streaming video resource locator into the client application, which is then transferred from the client application to the selected edge server. The edge server uses the resource locator to initiate a connection with the origin server to request the streaming video. As the edge server receives the streaming video data from the origin server, it will copy and transmit that video data to any client application that it is connected to and that has requested the streaming video.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a block diagram illustrating typical streaming video network;

FIG. 2 is a block diagram illustrating streaming network 20 configured according to one embodiment of the present invention;

FIG. 3 is a block diagram illustrating streaming network 30 configured according to one embodiment of the present invention;

FIG. 4 is a flowchart illustrating steps executed in implementing one embodiment of the present invention; and

FIG. 5 illustrates computer system 500 adapted to use embodiments of the present invention

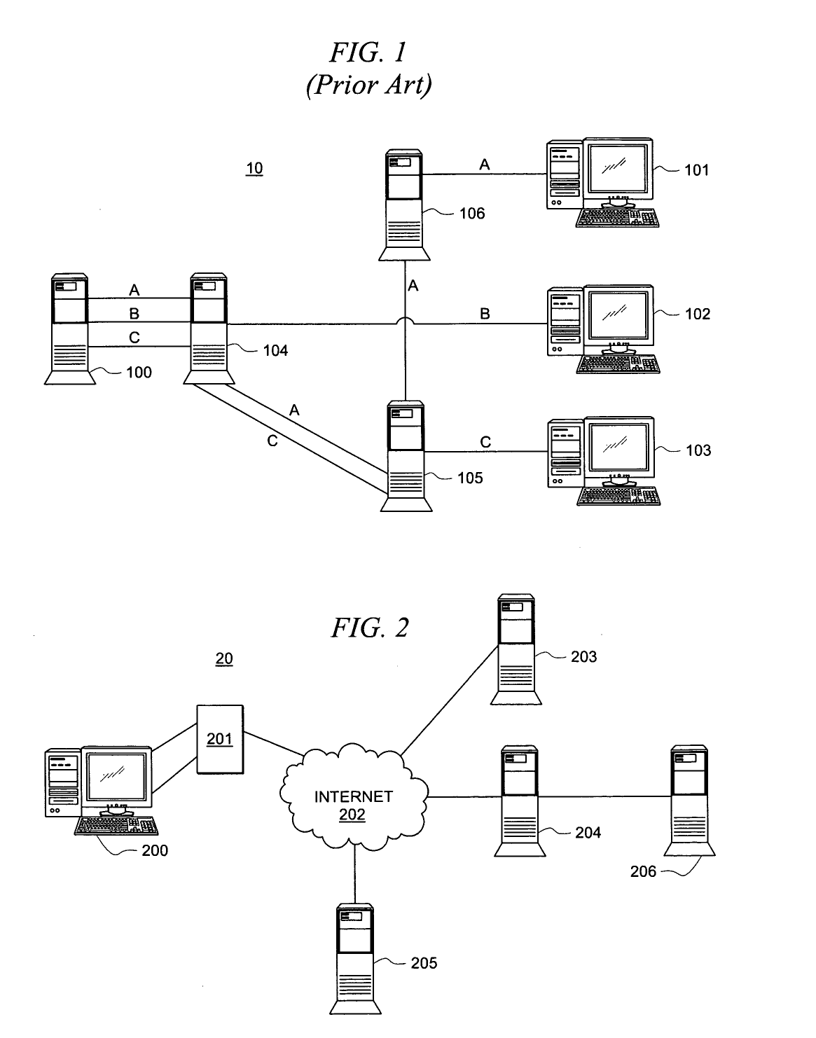

### DETAILED DESCRIPTION OF THE INVENTION

FIG. 2 is a block diagram illustrating streaming network 20 configured according to one embodiment of the present invention. Streaming network 20 includes origin server 206, smart edge servers 203-205, and participating client 200. Participating client 200 includes client-player 201 that facilitates viewing streaming video. Streaming network 20 may be a collaboration network configured according to co-pending, commonly-assigned U.S. patent application Ser. No. 11/263,652 entitled, “NETWORK CONFIGURATION WITH SMART EDGE SERVERS,” the disclosure of which is incorporated herein by reference. Thus smart edge servers 203-205 include logic that assists origin server 206 in managing streaming network 20. Additionally, smart edge servers 203-205 maintain and manage high speed connections with origin server 206. In order to connect into this network, client-player 201 connects to any one of smart edge servers 203-205 through Internet 202.

When a user at client 200 desires to subscribe to a video stream originating at origin server 206, the user enters a locating identifier, such as a Uniform Resource Locator (URL), for the desired video stream on origin server 206. Client-player 201 broadcasts a discovery request seeking the best available edge server to use in participating in streaming network 20. Smart edge servers 203-205 receive the discovery request from client-player 201 and analyzes their capability and availability for providing connection to a streaming video in streaming network 20. Smart edge servers 203-205, which receive the discovery request, may be the geographically or electronically closest edge servers that are available to participate in streaming network 20. Client-player 201 receives a discovery acknowledgement from one or more of smart edge servers 203-205 indicating that the server is available. Based on some selection mechanism, such as first acknowledgment received, closest server, lowest traffic, or the like, client-player 201 establishes communication with one of the acknowledging edge servers, such as smart edge server 204, and transmits the URL to smart edge server 204 for obtaining the streaming video. The user does not see any of these management processes that client-player 201 performs with regard to discovering the available edge servers or connecting to the available acknowledging edge server. The user only enters the URL for the desired video stream and believes that a connection is being made directly to origin server 206.

Moreover, the logic for discovering the available edge servers and making the connections to the edge servers is contained in client-player 201. Thus, standard streaming applications that play using client-player 201 can take advantage of the beneficial effects from the various embodiments of the present invention without modification.

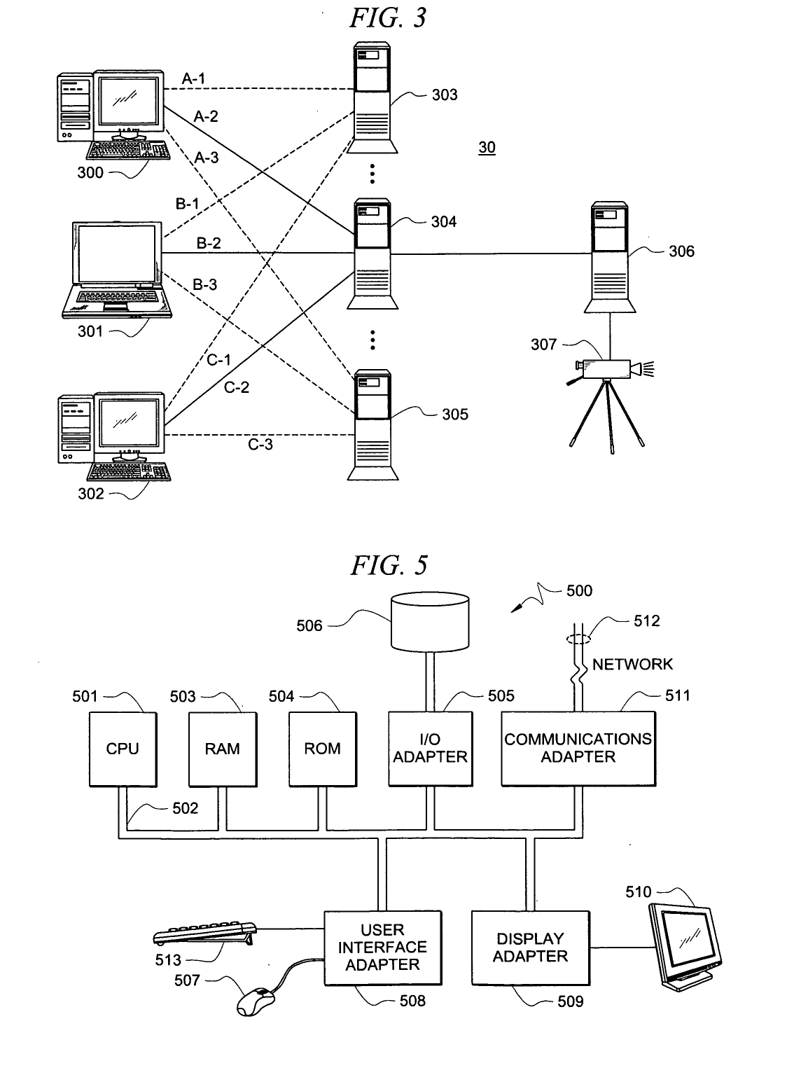

FIG. 3 is a block diagram illustrating streaming network 30 configured according to one embodiment of the present invention. Central server 306 receives a live video source from camera 307. Streaming network 30 makes a video stream of the live video source available to subscribing clients that access central server 306 using a URL that identifies the video stream of the live video source from cameral 307. A user at client computer 300 desires to subscribe to the video stream and enters the URL. Client computer 300 broadcasts discovery requests A-1, A-2, and A-3, which are received by edge servers 303-305, respectively. Edge server 304 responds with an acknowledgement that it can handle the streaming video request. Client computer 300 begins a communication session with edge server 304 and transmits the URL for the streaming video to edge server 304. Edge server 304 establishes a communication connection with central server 306 and subscribes to the streaming video of the live video source using the URL. Central server 306 then begins transmitting a copy of the streaming video to edge server 304. Edge server 304 then begins transmitting a copy of the video stream to client computer 300.

A user at client computer 301 also desires to subscribe to the streaming video and enters the URL into client computer 301. Client computer 301 broadcasts discovery requests B-1, B-2, and B-3, which are received by edge servers 303-305. Edge server 304 responds with an acknowledgement to client computer 301. Client computer 301 establishes a connection with edge server 304 and transmits the URL entered by the user to edge server 304. Because edge server 304 is already part of the transmission of the streaming video to client computer 300, it makes another copy of the video stream from central server 306 for transmission to client computer 301. At some point during communication between edge server 304 and central server 306, edge server 304 informs central server 306 that client computer 301 is subscribing to the video stream. This allows central server 306 to manage the implementation of streaming network 30, which also pushes out some of the network workload to edge server 304.

In a similar manner, a user at client 302 desires to subscribe to the streaming video and enters the URL into client computer 302. After making discovery requests C-1, C-2, and C-3, again, received by edge servers 303-305, respectively, client computer 302 makes the connection with edge server 304, which begins making yet another copy of the video stream from central server 306. This copy is then streamed to client computer 302 for display to the user.

It should be noted that while edge server 304 maintains three separate connections for the streaming video to client computers 300-302, the embodiment of the present invention depicted in FIG. 3 maintains only a single connection between edge server 304 and central server 306. This bandwidth management is performed using technology described in co-pending, commonly-assigned U.S. patent application Ser. No. 11/263,074 entitled, “VIRTUAL GROUP CONNECTION,” the disclosure of which is incorporated herein by reference. Using this technology, streaming network 30 is highly scalable, enabling central server 306 to maintain and service the participation of a number of users even beyond its direct load capacity. By using edge servers 303-305 and the group connection technology referred to above, even though multiple users may be connected to each individual edge server, central server 306 still only experiences one connection per edge server.

It should further be noted that additional or alternative embodiments of the present invention may perform the edge server discovery procedure at anytime while the client computer is active. A user would not necessarily have to make a URL request for a video stream for the client computer to obtain the information and availability of the closest and/or more favorable edge servers.

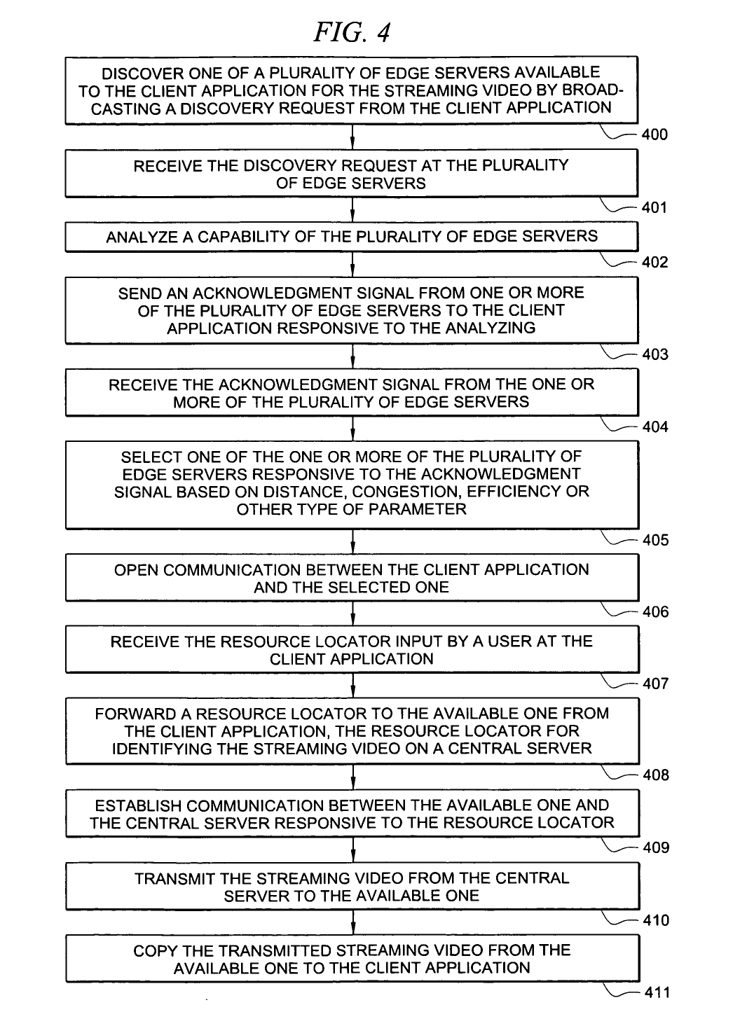

FIG. 4 is a flowchart illustrating example steps executed in implementing one embodiment of the present invention. In step 400, the client application attempts to discover one of several edge servers that is available to the client application for the streaming video by broadcasting a discovery request from the client application. In step 401, the edge servers receive the discovery request and, in step 402, analyze their individual capabilities and availability. An acknowledgment signal is then sent to the client application, in step 403, from one or more of the edge servers responsive to the analyzing. In step 404, the client application receives the acknowledgment signal from the responding edge servers. The client application selects one of the edge servers, in step 405, responsive to the acknowledgment signal and based on properties such as distance, congestion, efficiency or other types of parameters.

In step 406, communication is opened between the client application and the selected edge server. A user inputs the resource locator, in step 407, into the client application. This resource locator is forwarded, in step 408, from the client application to the selected edge server. The resource locator identifies the location of the streaming video on a central server. Communication is established using the resource locator, in step 409, between the selected edge server and the central server. The streaming video is then transmitted, in step 410, from the central server to the available one. In step 411, the transmitted streaming video is copied from the selected edge server to the client application.

The program or code segments making up the various embodiments of the present invention may be stored in a computer readable medium or transmitted by a computer data signal embodied in a carrier wave, or a signal modulated by a carrier, over a transmission medium. The “computer readable medium” may include any medium that can store or transfer information. Examples of the computer readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, and the like. The computer data signal may include any signal that can propagate over a transmission medium such as electronic network channels, optical fibers, air, electromagnetic, RF links, and the like. The code segments may be downloaded via computer networks such as the Internet, Intranet, and the like.

FIG. 5 illustrates computer system 500 adapted to use embodiments of the present invention, e.g. storing and/or executing software associated with the embodiments. Central processing unit (CPU) 501 is coupled to system bus 502. The CPU 501 may be any general purpose CPU. However, embodiments of the present invention are not restricted by the architecture of CPU 501 as long as CPU 501 supports the inventive operations as described herein. Bus 502 is coupled to random access memory (RAM) 503, which may be SRAM, DRAM, or SDRAM. ROM 504 is also coupled to bus 502, which may be PROM, EPROM, or EEPROM. RAM 503 and ROM 504 hold user and system data and programs as is well known in the art.

Bus 502 is also coupled to input/output (I/O) controller card 505, communications adapter card 511, user interface card 508, and display card 509. The I/O adapter card 505 connects storage devices 506, such as one or more of a hard drive, a CD drive, a floppy disk drive, a tape drive, to computer system 500. The I/O adapter 505 is also connected to a printer (not shown), which would allow the system to print paper copies of information such as documents, photographs, articles, and the like. Note that the printer may be a printer (e.g., dot matrix, laser, and the like), a fax machine, scanner, or a copier machine. Communications card 511 is adapted to couple the computer system 500 to a network 512, which may be one or more of a telephone network, a local (LAN) and/or a wide-area (WAN) network, an Ethernet network, and/or the Internet network. User interface card 508 couples user input devices, such as keyboard 513, pointing device 507, and the like, to the computer system 500. The display card 509 is driven by CPU 501 to control the display on display device 510.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A computer implemented method comprising:
broadcasting a discovery request from a client application running on a client computer to a plurality of edge servers;
receiving two or more acknowledgement signals at said client application from two or more of said plurality of edge servers, respectively;
selecting an available one of said plurality of edge servers by said client application responsive to said receiving;
forwarding a resource locator to said selected available one from said client application, said forwarded resource locator for identifying a streaming video on a central server, wherein said forwarded resource locator causes said selected available one to establish communication between said selected available one and said central server; and
receiving, at the client application, a copy of a streaming video transmission from said selected available one, wherein said selected available one received said streaming video transmission from said central server in response to the forwarding,
wherein the central server manages a streaming network comprising the central server and the plurality of edge servers,
wherein the plurality of edge servers assist the central server in managing the streaming network, and wherein participating client computers connect into the streaming network by connecting to any one of the two or more of the plurality of edge servers,
wherein the discovery request seeks a best available edge server to stream the streaming video to the client application, and
wherein each of the two or more acknowledgement signals includes an indication that the corresponding edge server is available to stream a streaming video to the client application.

2. The method of claim 1 further comprising:
receiving said resource locator input by a user at said client application.

3. The method of claim 1 further comprising:
receiving said discovery request at said plurality of edge servers;
analyzing, at each of said plurality of edge servers, a corresponding computational and network resources available to stream said streaming video transmission to said client application; and
sending said two or more acknowledgment signals from respective two or more of said plurality of edge servers to said client application responsive to said analyzing.

4. (canceled)

5. The method of claim 1 wherein said selecting comprises selecting said one based on one or more of:
a distance between said client application and said selected one of said plurality of edge servers;
a congestion level of said selected one of said plurality of edge servers; and
an efficiency of said selected one of said plurality of edge servers.

6-16. (canceled)

17. A computer implemented method comprising:
receiving a discovery request at each of a plurality of edge servers of a streaming video network, said discovery request broadcast by a client application running on a client computer;
analyzing corresponding computational and network resources available of said each of said plurality of edge servers to transmit a streaming video to said client application;
responsive to said analyzing, transmitting two or more acknowledgment signals from each of two or more of said plurality of edge servers, respectively;
receiving at one of said two or more of said plurality of edge servers a resource locator from said client application, said resource locator identifying said streaming video on a central server of said streaming network;
responsive to receiving said resource locator, requesting said streaming video from said central server using said resource locator;
receiving a stream of said streaming video from central server at said one of said two or more of said plurality of edge servers; and
transmitting said stream of said streaming video to said client application,
wherein the central server manages the streaming video network comprising the central server and the plurality of edge servers,
wherein the plurality of edge servers assist the central server in managing the streaming video network, and wherein participating client computers connect into the streaming video network by connecting to any one of the two or more of the plurality of edge servers,
wherein the discovery request seeks a best available edge server to stream the streaming video to the client application, and
wherein each of the two or more acknowledgement signals includes an indication that the corresponding edge server is available to stream the streaming video to the client application.

18. The computer implemented method of claim 17 further comprising:
receiving at said client application running on the client computer said two or more acknowledgment signals from each of said two or more of said plurality of edge servers;
responsive to receiving said two or more acknowledgement signals, selecting said one of said two or more of said plurality of edge servers; and
transmitting said resource locator from said client application to said one of said two or more of said plurality of edge servers.

19. The computer implemented method of claim 18 wherein said selecting is based on one or more of:
a distance between said client application and said selected one of said plurality of edge servers;
a congestion level of said selected one of said plurality of edge servers; and
an efficiency of said selected one of said plurality of edge servers.

20. A computer program product having a computer readable storage medium with computer program logic recorded thereon, said computer program product comprising:
code for broadcasting a discovery request from a client application running on a client computer to a plurality of edge servers;
code for receiving two or more acknowledgement signals at said client application from two or more of said plurality of edge servers, respectively;
code for selecting an available one of said plurality of edge servers by said client application responsive to execution of said code for receiving;
code for forwarding a resource locator to said selected available one from said client application, said forwarded resource locator for identifying a streaming video on a central server, wherein said forwarded resource locator causes said selected available one to establish communication between said selected available one and said central server; and
code for receiving, at the client application, a copy of a streaming video transmission from said selected available one, wherein said selected available one received said streaming video transmission from said central server in response to the forwarding,
wherein the central server manages a streaming network comprising the central server and the plurality of edge servers,
wherein the plurality of edge servers assist the central server in managing the streaming network, and wherein participating client computers connect into the streaming network by connecting to any one of the two or more of the plurality of edge servers,
wherein the discovery request seeks a best available edge server to stream the streaming video to the client application, and
wherein each of the two or more acknowledgement signals includes an indication that the corresponding edge server is available to stream a streaming video to the client application.

21. The computer program product of claim 20 further comprising:
code for receiving said resource locator input by a user at said client computer.

22. The computer program product of claim 20 further comprising:
receiving said discovery request at said plurality of edge servers;
analyzing, at each of said plurality of edge servers, corresponding computational and network resources available to stream said streaming video transmission to said client application; and
sending said two or more acknowledgment signals from respective two or more of said plurality of edge servers to said client application responsive to said analyzing.

23. The computer program product of claim 20 wherein said code for selecting comprises code for selecting said available one based on one or more of:
a distance between said client application and said selected one of said plurality of edge servers;
a congestion level of said selected one of said plurality of edge servers; and
an efficiency of said selected one of said plurality of edge servers.

24. A system comprising:
a client computer having a central processing unit (CPU);
a storage device coupled to said CPU;
a communications adapter coupled to said CPU, wherein said communications adapter is configured to connect said client computer to a streaming network;
a client application stored on said storage device, wherein, when executed by said CPU, said client application:
configures said communications adapter to broadcast a discovery request to a plurality of edge servers within said streaming network;
configures said communications adapter to receive two or more acknowledgement signals from two or more of said plurality of edge servers computer, wherein said executed client application is configured to select one of said one or more of said plurality of edge servers responsive to receiving said acknowledgement signal;
further configures said communications adapter to transmit a resource locator to said one of said one or more of said plurality of edge servers, said resource locator identifying a streaming video on a central server of said streaming network; and
further configures said communications adapter to receive a copy of said streaming video from said one of said one or more of said plurality of edge servers, said one of said one or more of said plurality of edge servers receiving said streaming video from said central server,
wherein the central server manages the streaming network comprising the central server and the plurality of edge servers,
wherein the plurality of edge servers assist the central server in managing the streaming network, and wherein participating client computers connect into the streaming network by connecting to any one of the two or more of the plurality of edge servers,
wherein the discovery request seeks a best available edge server to stream the streaming video to the client application, and
wherein each of the two or more acknowledgement signals includes an indication that the corresponding edge server is available to stream a streaming video to the client application.

25. The system of claim 24 further comprising:
one or more user input devices coupled to said CPU, wherein said executed client application configures said one or more user input devices to receive input from a user requesting to connect to said streaming video and wherein said broadcast of said discovery request is configured in response to said input.

26. The system of claim 24 wherein receipt of said resource locator by said one of said one or more of said plurality of edge servers causes said one to establish a communication link with said central server and request said streaming video using said resource locator.

27. The system of claim 24 further comprising:
a display device coupled to said CPU, wherein said CPU processes said copy of said streaming video to display said copy on said display device.

28. The system of claim 24 wherein said executed client application selects said one of said one or more of said plurality of edge servers based on one or more of:
a distance between said client computer and said selected one of said plurality of edge servers;
a congestion level of said selected one of said plurality of edge servers; and
an efficiency of said selected one of said plurality of edge servers.
